(19) United States
(12) Patent Application Publication
(10) Pub. No.: US 2026/0278840 A1
(43) Pub. Date: Sep. 17, 2026

(54) CAMERA CALIBRATION BASED ON INFORMATION FROM EXTERNAL SOURCES FOR VEHICLE APPLICATIONS

(71) Applicant: QUALCOMM Incorporated, San Diego, CA (US)

(72) Inventors: Anantharaman Balasubramanian, San Diego, CA (US); Kapil Gulati, Belle Mead, NJ (US); Stelios Stefanatos, San Diego, CA (US)

(21) Appl. No.: 19/471,287

(22) PCT Filed: Apr. 3, 2024
(86) PCT No.: PCT/US2024/022853

§ 371 Date: Sep. 30, 2025

(30) Foreign Application Priority Data
Jun. 9, 2023 (GR) 20230100460

(51) Int. Cl. G06T 7/80; G06T 7/00; G06T 7/73

(52) U.S. Cl. CPC G06T 7/80; G06T 7/73; G06T 7/97; G06T 2207/30244; G06T 2207/30252

(57) ABSTRACT

This disclosure provides systems, methods, and devices for vehicle driving assistance systems that support image processing. In a first aspect, a method of image processing includes receiving, from a camera, first image data, from a first source, second image data and first pose information, and from a second source, third image data and second pose information. A field-of-view of the camera overlaps with a fieldof-view of the first source and with a field-of-view of the second source. Third pose information of the camera is determined based on the first image data, second image data, third image data, the first pose information, and the second pose information. Other aspects and features are also claimed and described.

### CROSS-REFERENCE TO RELATED APPLICATIONS

This application claims the benefit of Greek patent application No. 20230100460, entitled, “CAMERA CALIBRATION BASED ON INFORMATION FROM EXTERNAL SOURCES FOR VEHICLE APPLICATIONS,” filed on Jun. 9, 2023, which is expressly incorporated by reference herein in its entirety.

### TECHNICAL FIELD

Aspects of the present disclosure relate generally to camera calibration, and more particularly, to methods and systems suitable for enhancing driving assistance systems by calibrating a camera based on information received from at least two image sources external to the camera, such as sensors of vehicles.

### INTRODUCTION

Vehicles take many shapes and sizes, are propelled by a variety of propulsion techniques, and carry cargo including humans, animals, or objects. These machines have enabled the movement of cargo across long distances, movement of cargo at high speed, and movement of cargo that is larger than could be moved by human exertion. Vehicles originally were driven by humans to control speed and direction of the cargo to arrive at a destination. Human operation of vehicles has led to many unfortunate incidents resulting from the collision of vehicle with vehicle, vehicle with object, vehicle with human, or vehicle with animal. As research into vehicle automation has progressed, a variety of driving assistance systems have been produced and introduced. These include navigation directions by GPS, adaptive cruise control, lane change assistance, collision avoidance systems, night vision, parking assistance, and blind spot detection. Data from public surveillance cameras can enhance the driving assistance systems (e.g., advanced driver-assistance system (ADAS) map information) for automated and non-automated vehicles.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Human operators of vehicles can be distracted, which is one factor in many vehicle crashes. Driver distractions can include changing the radio, observing an event outside the vehicle, and using an electronic device, etc. Sometimes circumstances create situations that even attentive drivers are unable to identify in time to prevent vehicular collisions. Aspects of this disclosure, provide improved systems for assisting drivers in vehicles with enhanced situational awareness when driving on a road. For instance, public surveillance cameras (e.g., traffic cameras) can enhance the driving assistance systems of automated and non-automated vehicles, such as by enhancing the advanced driver-assistance system (ADAS) map information for automated and non-automated vehicles. Aspects of this disclosure provide camera calibration techniques to determine 3D positional coordinates of the camera based on image data captured by the camera and image coordinates of image data captured by other cameras having overlapping fields of view with the camera to be calibrated. The provided techniques enable a computing device (e.g., a car-to-cloud server) to leverage the already known pose (e.g., location and orientation) of multiple cameras (e.g., driving assistance system cameras of vehicles) that have overlapping fields-of-view with the public surveillance camera in order to determine calibration parameters of the public surveillance camera. The calibration parameters may indicate a pose of the camera. The calibration parameters may improve the accuracy for tracking of small (or large) movements of the public surveillance camera (e.g., a traffic camera) over time due to wind, ground movement, structure fatigue, and other environmental or aging factors. The higher accuracy in the known position and direction of the camera improves the information that can be inferred from the recorded images, such as position and speed of objects in the field-of-view of the camera.

Example embodiments provide techniques for calibrating a traffic camera based on cameras included with driving assistance systems of vehicles. The driving assistance systems of these vehicles transmit high accuracy position information (e.g., location and orientation) of the vehicles (e.g., as part of a Basic Safety Message (BSM)) to a server (e.g., a car-to-cloud server). The server may receive image data from the traffic camera and from each of the vehicle cameras, which may be automatically sent or subsequent to a request from the server. The image data from each of the traffic camera and the vehicle cameras may include keypoints and descriptors of portions of the scene represented by the image data. Shared keypoints between the traffic camera and the vehicle cameras may be determined and used to calculate an orientation and distance of the traffic camera relative to each of the vehicle cameras. With the known location and orientation of the vehicle cameras, the calculated orientation and distance of the traffic camera relative to each of the vehicle cameras, and a keypoint shared by each of the traffic camera and vehicle cameras, 3D positional coordinates of the traffic camera can be determined (e.g., triangulated). When the traffic camera is properly calibrated, the accurate and reliable data from the traffic camera can enhance the driving assistance systems (e.g., the ADAS map information) of vehicles.

In some embodiments, the cameras of the driving assistance systems may instead be cameras included with a smartphone or other suitable cameras.

In one aspect of the disclosure, a method for image processing for use with a vehicle assistance system includes receiving, from a camera, first image data representing a first field-of view of the camera; receiving, from a first source, second image data based on a first image capture device of the first source; receiving, from the first source, first pose information of the first image capture device; receiving, from a second source, third image data based on a second image capture device of the second source; receiving, from the second source, second pose information of the second image capture device; and determining, by a processor, third pose information of the camera based on the first image data, the second image data, the third image data, the first pose information, and the second pose information. The second image data represents a second field-of-view of the first image capture device, and the second field-of-view overlaps at least partially with the first field-of-view. The third image data represents a third field-of-view of the second image capture device, and the third field-of-view overlaps at least partially with the first field-of-view.

In an additional aspect of the disclosure, an apparatus includes at least one processor and a memory coupled to the at least one processor. The at least one processor is configured to perform operations including receiving, from a camera, first image data representing a first field-of view of the camera; receiving, from a first source, second image data based on a first image capture device of the first source; receiving, from the first source, first pose information of the first image capture device; receiving, from a second source, third image data based on a second image capture device of the second source; receiving, from the second source, second pose information of the second image capture device; and determining, by a processor, third pose information of the camera based on the first image data, the second image data, the third image data, the first pose information, and the second pose information. The second image data represents a second field-of-view of the first image capture device, and the second field-of-view overlaps at least partially with the first field-of-view. The third image data represents a third field-of-view of the second image capture device, and the third field-of-view overlaps at least partially with the first field-of-view.

In an additional aspect of the disclosure, a non-transitory computer-readable medium stores instructions that, when executed by a processor, cause the processor to perform operations. The operations include receiving, from a camera, first image data representing a first field-of view of the camera; receiving, from a first source, second image data based on a first image capture device of the first source; receiving, from the first source, first pose information of the first image capture device; receiving, from a second source, third image data based on a second image capture device of the second source; receiving, from the second source, second pose information of the second image capture device; and determining, by a processor, third pose information of the camera based on the first image data, the second image data, the third image data, the first pose information, and the second pose information. The second image data represents a second field-of-view of the first image capture device, and the second field-of-view overlaps at least partially with the first field-of-view. The third image data represents a third field-of-view of the second image capture device, and the third field-of-view overlaps at least partially with the first field-of-view.

In an additional aspect of the disclosure, an apparatus includes at least one processor and a memory coupled to the at least one processor. The at least one processor is configured to perform operations including receiving, from a first traffic camera, first image data; receiving, from each vehicle of a plurality of vehicles, second image data captured by a respective camera of each vehicle of the plurality of vehicles; receiving, from each vehicle of the plurality of vehicles, first pose information of the respective camera of each vehicle of the plurality of vehicles; determining second pose information of the first traffic camera based on the first image data, the second image data of each vehicle of the plurality of vehicles, and the first pose information of each vehicle of the plurality of vehicles; receiving, from a second traffic camera, third image data; receiving, from each vehicle of a plurality of vehicles, fourth image data captured by the respective camera of each vehicle of the plurality of vehicles; receiving, from each vehicle of the plurality of vehicles, third pose information of the respective camera of each vehicle of the plurality of vehicles; determining fourth pose information of the second traffic camera based on the third image data, the fourth image data of each vehicle of the plurality of vehicles, and the third pose information of each vehicle of the plurality of vehicles.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) ng networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). 5G networks include diverse deployments, diverse spectrum, and diverse services and devices that may be implemented using an OFDM-based unified, air interface.

The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur.

Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes .1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a perspective view of a motor vehicle with a driver monitoring system according to embodiments of this disclosure.

FIG. 2 shows a block diagram of an example image processing configuration for a vehicle according to one or more aspects of the disclosure.

FIG. 3 is a block diagram illustrating details of an example wireless communication system according to one or more aspects.

FIG. 4 is a block diagram illustrating a computer network for calibrating a camera according to one or more aspects of the disclosure.

FIG. 5 is a flow chart illustrating an example method for calibrating a camera according to one or more aspects of the disclosure.

FIG. 6A is an example of a vehicle's image capture device having an overlapping field-of-view with a camera.

FIG. 6B another example of a vehicle's image capture device having an overlapping field-of-view with a camera.

FIG. 7 is a schematic showing a triangulated camera location.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

Public surveillance cameras (e.g., traffic cameras) can enhance the driving assistance systems of automated and non-automated vehicles, such as by increasing the accuracy and reliability of the advanced driver-assistance system (ADAS) map information for automated and non-automated vehicles. Extrinsic parameters of such public surveillance cameras, however, can change since such cameras may turn (e.g., with six degrees of motion) due to wind or other environmental factors, thus requiring the public surveillance camera to be calibrated so that accurate information is provided. It is impractical, however, to manually determine calibration of several thousands of public surveillance cameras that are typically installed in a city or county. Further, camera calibration information is typically not available to automatically calibrate the public surveillance cameras wirelessly. For instance, a public surveillance camera's pose with respect to a world coordinate system (e.g., GPS) is typically not known. Without such information, it's not possible to convert an observed image point to a 3D coordinate on a world coordinate system.

One typical approach for automated camera calibration in the use case of vehicles is using known geometric fixtures, such as vehicle keypoints corresponding to left-right taillights, license plate, left/right side mirrors, rear brake light, etc. This typical approach, however, has limitations in its use. The output of such typical approaches is not on a world coordinate system. The road in the car images is assumed to be flat (no undulations). And the vehicle's geometric properties (e.g., distance between the two taillights of a specific make and model of a vehicle) is assumed to be known.

The present disclosure provides systems, apparatus, methods, and computer-readable media that support camera calibration techniques to determine 3D positional coordinates of the camera based on image data captured by the camera and image coordinates of image data captured by other cameras having overlapping fields of view with the camera to be calibrated. The provided techniques enable a computing device (e.g., a car-to-cloud server) to leverage the already known poses of multiple cameras that have overlapping fields-of-view with the public surveillance camera in order to determine calibration parameters of the public surveillance camera.

For example, the camera to be calibrated may be a traffic camera and the other cameras may be cameras included with driving assistance systems of vehicles. The driving assistance systems of these vehicles automatically transmit high accuracy position information (e.g., location and orientation) of the vehicles (e.g., as part of a BSM) to a server (e.g., a car-to-cloud server). The server may receive image data from the traffic camera and from each of the vehicle cameras, which may be automatically sent or sent subsequent to a request from the server. The image data from each of the traffic camera and the vehicle cameras may include keypoints and descriptors of portions of the scene represented by the image data. Shared keypoints between the traffic camera and the vehicle cameras may be determined and used to calculate an orientation and distance of the traffic camera relative to each of the vehicle cameras. With the known location and orientation of the vehicle cameras, the calculated orientation and distance of the traffic camera relative to each of the vehicle cameras, and a keypoint shared by each of the traffic camera and vehicle cameras, 3D positional coordinates of the traffic camera can be determined (e.g., triangulated). When the traffic camera is properly calibrated, the accurate and reliable data from the traffic camera can enhance the driving assistance systems (e.g., the ADAS map information) of vehicles. For instance, the calibrated traffic camera captures a large amount of image data of the scene in view of the traffic camera, from which accurate and reliable information regarding the scene can be extracted. The extracted information can be used to accurately and reliably train (e.g., initial training or update training) a machine learning model of a driving assistance system with respect to the scene in view of the traffic camera. When repeated for a large number of traffic cameras, the model can be accurately and reliably trained for an area.

Particular implementations of the subject matter described in this disclosure may be implemented to realize one or more of the following potential advantages or benefits. In some aspects, the present disclosure provides techniques for image processing that may be particularly beneficial in smart vehicle applications. For example, the provided techniques can leverage crowdsourcing of multiple image capturing devices (e.g., vehicle cameras) that have overlapping fields-of-view with that of a public surveillance camera, such as a traffic camera, in order to calibrate the pose (e.g., location and orientation) of the public surveillance camera. Hence, it is possible to average out the effect of the noise in determining the public surveillance camera calibration. Another advantage of the provided techniques is the ability to determine the actual location of the public surveillance camera even though the relative orientation between the camera and the vehicle cameras will only provide a relative distance between the public surveillance camera and the vehicle cameras. For instance, the crowdsourcing effect of information from many vehicles may enable the public surveillance camera's location to be pinpointed on a world coordinate system. Additionally, the calibrated public surveillance camera outputs accurate and reliable information regarding a scene in view of the calibrated public surveillance camera, and such accurate and reliable information can be leveraged for other uses, such as increasing the accuracy and reliability of map information. For example, the map information may be ADAS map information or interactive map information viewed on various computing devices (e.g., laptop, smartphone, etc.)

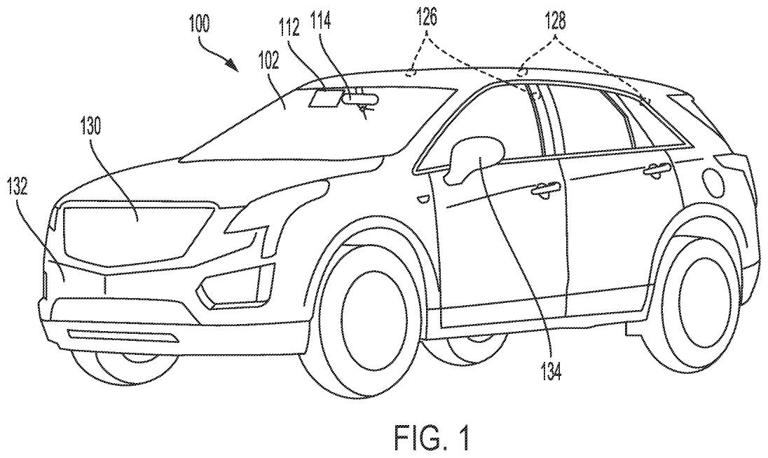

FIG. 1 is a perspective view of a motor vehicle with a driver monitoring system according to embodiments of this disclosure. A vehicle 100 may include a front-facing camera 112 mounted inside the cabin looking through the windshield 102. The vehicle may also include a cabin-facing camera 114 mounted inside the cabin looking towards occupants of the vehicle 100, and in particular the driver of the vehicle 100. Although one set of mounting positions for cameras 112 and 114 are shown for vehicle 100, other mounting locations may be used for the cameras 112 and 114. For example, one or more cameras may be mounted on one of the driver or passenger B pillars 126 or one of the driver or passenger C pillars 128, such as near the top of the pillars 126 or 128. As another example, one or more cameras may be mounted at the front of vehicle 100, such as behind the radiator grill 130 or integrated with bumper 132. As a further example, one or more cameras may be mounted as part of a driver or passenger side mirror assembly 134.

The camera 112 may be oriented such that the field of view of camera 112 captures a scene in front of the vehicle 100 in the direction that the vehicle 100 is moving when in drive mode or forward direction. In some embodiments, an additional camera may be located at the rear of the vehicle 100 and oriented such that the field of view of the additional camera captures a scene behind the vehicle 100 in the direction that the vehicle 100 is moving when in reverse direction. Although embodiments of the disclosure may be described with reference to a “front-facing” camera, referring to camera 112, aspects of the disclosure may be applied similarly to a “rear-facing” camera facing in the reverse direction of the vehicle 100. Thus, the benefits obtained while the operator is driving the vehicle 100 in a forward direction may likewise be obtained while the operator is driving the vehicle 100 in a reverse direction.

Further, although embodiments of the disclosure may be described with reference a “front-facing” camera, referring to camera 112, aspects of the disclosure may be applied similarly to an input received from an array of cameras mounted around the vehicle 100 to provide a larger field of view, which may be as large as 360 degrees around parallel to the ground and/or as large as 360 degrees around a vertical direction perpendicular to the ground. For example, additional cameras may be mounted around the outside of vehicle 100, such as on or integrated in the doors, on or integrated in the wheels, on or integrated in the bumpers, on or integrated in the hood, and/or on or integrated in the roof.

The camera 114 may be oriented such that the field of view of camera 114 captures a scene in the cabin of the vehicle and includes the user operator of the vehicle, and in particular the face of the user operator of the vehicle with sufficient detail to discern a gaze direction of the user operator.

Each of the cameras 112 and 114 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

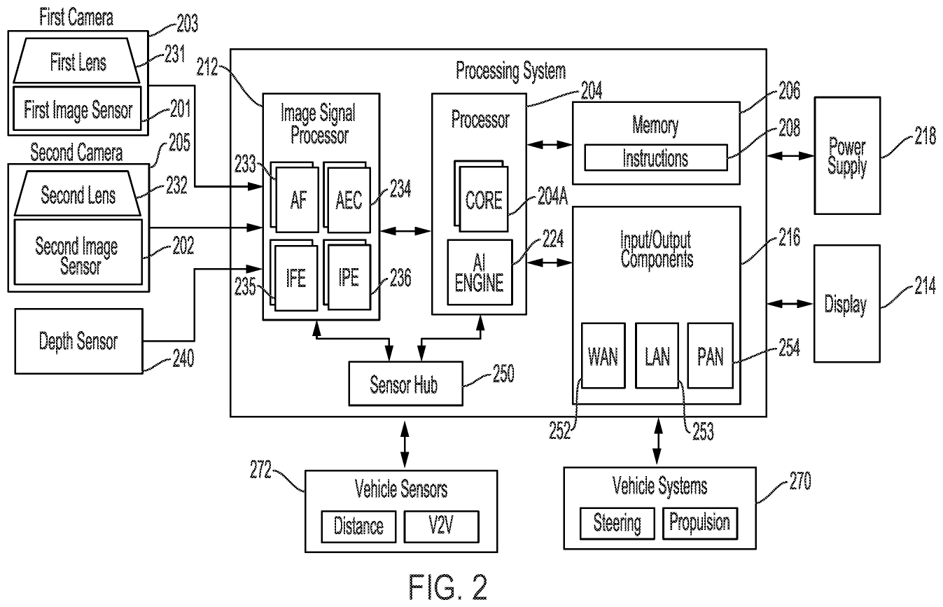

FIG. 2 shows a block diagram of an example image processing configuration for a vehicle according to one or more aspects of the disclosure. The vehicle 100 may include, or otherwise be coupled to, an image signal processor 212 for processing image frames from one or more image sensors, such as a first image sensor 201, a second image sensor 202, and a depth sensor 240. In some implementations, the vehicle 100 also includes or is coupled to a processor (e.g., CPU) 204 and a memory 206 storing instructions 208. The device 100 may also include or be coupled to a display 214 and input/output (I/O) components 216. I/O components 216 may be used for interacting with a user, such as a touch screen interface and/or physical buttons. I/O components 216 may also include network interfaces for communicating with other devices, such as other vehicles, an operator's mobile devices, and/or a remote monitoring system. The network interfaces may include one or more of a wide area network (WAN) adaptor 252, a local area network (LAN) adaptor 253, and/or a personal area network (PAN) adaptor 254. An example WAN adaptor 252 is a 4G LTE or a 5G NR wireless network adaptor. An example LAN adaptor 253 is an IEEE 802.11 WiFi wireless network adapter. An example PAN adaptor 254 is a Bluetooth wireless network adaptor. Each of the adaptors 252, 253, and/or 254 may be coupled to an antenna, including multiple antennas configured for primary and diversity reception and/or configured for receiving specific frequency bands. The vehicle 100 may further include or be coupled to a power supply 218, such as a battery or an alternator. The vehicle 100 may also include or be coupled to additional features or components that are not shown in FIG. 2. In one example, a wireless interface, which may include one or more transceivers and associated baseband processors, may be coupled to or included in WAN adaptor 252 for a wireless communication device. In a further example, an analog front end (AFE) to convert analog image frame data to digital image frame data may be coupled between the image sensors 201 and 202 and the image signal processor 212.

The vehicle 100 may include a sensor hub 250 for interfacing with sensors to receive data regarding movement of the vehicle 100, data regarding an environment around the vehicle 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub 250 may interface to a vehicle bus for sending configuration commands and/or receiving information from vehicle sensors 272, such as distance (e.g., ranging) sensors or vehicle-to-vehicle (V2V) sensors (e.g., sensors for receiving information from nearby vehicles).

The image signal processor (ISP) 212 may receive image data, such as used to form image frames. In one embodiment, a local bus connection couples the image signal processor 212 to image sensors 201 and 202 of a first camera 203, which may correspond to camera 112 of FIG. 1, and second camera 205, which may correspond to camera 114 of FIG. 1, respectively. In another embodiment, a wire interface may couple the image signal processor 212 to an external image sensor. In a further embodiment, a wireless interface may couple the image signal processor 212 to the image sensor 201, 202.

The first camera 203 may include the first image sensor 201 and a corresponding first lens 231. The second camera 205 may include the second image sensor 202 and a corresponding second lens 232. Each of the lenses 231 and 232 may be controlled by an associated autofocus (AF) algorithm 233 executing in the ISP 212, which adjust the lenses 231 and 232 to focus on a particular focal plane at a certain scene depth from the image sensors 201 and 202. The AF algorithm 233 may be assisted by depth sensor 240. In some embodiments, the lenses 231 and 232 may have a fixed focus.

The first image sensor 201 and the second image sensor 202 are configured to capture one or more image frames. Lenses 231 and 232 focus light at the image sensors 201 and 202, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging.

In some embodiments, the image signal processor 212 may execute instructions from a memory, such as instructions 208 from the memory 206, instructions stored in a separate memory coupled to or included in the image signal processor 212, or instructions provided by the processor 204. In addition, or in the alternative, the image signal processor 212 may include specific hardware (such as one or more integrated circuits (ICs)) configured to perform one or more operations described in the present disclosure. For example, the image signal processor 212 may include one or more image front ends (IFEs) 235, one or more image post-processing engines (IPEs) 236, and or one or more auto exposure compensation (AEC) 234 engines. The AF 233, AEC 234, IFE 235, IPE 236 may each include application-specific circuitry, be embodied as software code executed by the ISP 212, and/or a combination of hardware within and software code executing on the ISP 212.

In some implementations, the memory 206 may include a non-transient or non-transitory computer readable medium storing computer-executable instructions 208 to perform all or a portion of one or more operations described in this disclosure. In some implementations, the instructions 208 include a camera application (or other suitable application) to be executed during operation of the vehicle 100 for generating images or videos. The instructions 208 may also include other applications or programs executed for the vehicle 100, such as an operating system, mapping applications, or entertainment applications. Execution of the camera application, such as by the processor 204, may cause the vehicle 100 to generate images using the image sensors 201 and 202 and the image signal processor 212. The memory 206 may also be accessed by the image signal processor 212 to store processed frames or may be accessed by the processor 204 to obtain the processed frames. In some embodiments, the vehicle 100 includes a system on chip (SoC) that incorporates the image signal processor 212, the processor 204, the sensor hub 250, the memory 206, and input/output components 216 into a single package.

In some embodiments, at least one of the image signal processor 212 or the processor 204 executes instructions to perform various operations described herein, including object detection, risk map generation, driver monitoring, and driver alert operations. For example, execution of the instructions can instruct the image signal processor 212 to begin or end capturing an image frame or a sequence of image frames. In some embodiments, the processor 204 may include one or more general-purpose processor cores 204A capable of executing scripts or instructions of one or more software programs, such as instructions 208 stored within the memory 206. For example, the processor 204 may include one or more application processors configured to execute the camera application (or other suitable application for generating images or video) stored in the memory 206.

In executing the camera application, the processor 204 may be configured to instruct the image signal processor 212 to perform one or more operations with reference to the image sensors 201 or 202. For example, the camera application may receive a command to begin a video preview display upon which a video comprising a sequence of image frames is captured and processed from one or more image sensors 201 or 202 and displayed on an informational display on display 114 in the cabin of the vehicle 100.

In some embodiments, the processor 204 may include ICs or other hardware (e.g., an artificial intelligence (AI) engine 224) in addition to the ability to execute software to cause the vehicle 100 to perform a number of functions or operations, such as the operations described herein. In some other embodiments, the vehicle 100 does not include the processor 204, such as when all of the described functionality is configured in the image signal processor 212.

In some embodiments, the display 214 may include one or more suitable displays or screens allowing for user interaction and/or to present items to the user, such as a preview of the image frames being captured by the image sensors 201 and 202. In some embodiments, the display 214 is a touch-sensitive display. The I/O components 216 may be or include any suitable mechanism, interface, or device to receive input (such as commands) from the user and to provide output to the user through the display 214. For example, the I/O components 216 may include (but are not limited to) a graphical user interface (GUI), a keyboard, a mouse, a microphone, speakers, a squeezable bezel, one or more buttons (such as a power button), a slider, a switch, and so on. In some embodiments involving autonomous driving, the I/O components 216 may include an interface to a vehicle's bus for providing commands and information to and receiving information from vehicle systems 270 including propulsion (e.g., commands to increase or decrease speed or apply brakes) and steering systems (e.g., commands to turn wheels, change a route, or change a final destination).

While shown to be coupled to each other via the processor 204, components (such as the processor 204, the memory 206, the image signal processor 212, the display 214, and the I/O components 216) may be coupled to each another in other various arrangements, such as via one or more local buses, which are not shown for simplicity. While the image signal processor 212 is illustrated as separate from the processor 204, the image signal processor 212 may be a core of a processor 204 that is an application processor unit (APU), included in a system on chip (SoC), or otherwise included with the processor 204. While the vehicle 100 is referred to in the examples herein for including aspects of the present disclosure, some device components may not be shown in FIG. 2 to prevent obscuring aspects of the present disclosure. Additionally, other components, numbers of components, or combinations of components may be included in a suitable vehicle for performing aspects of the present disclosure. As such, the present disclosure is not limited to a specific device or configuration of components, including the vehicle 100.

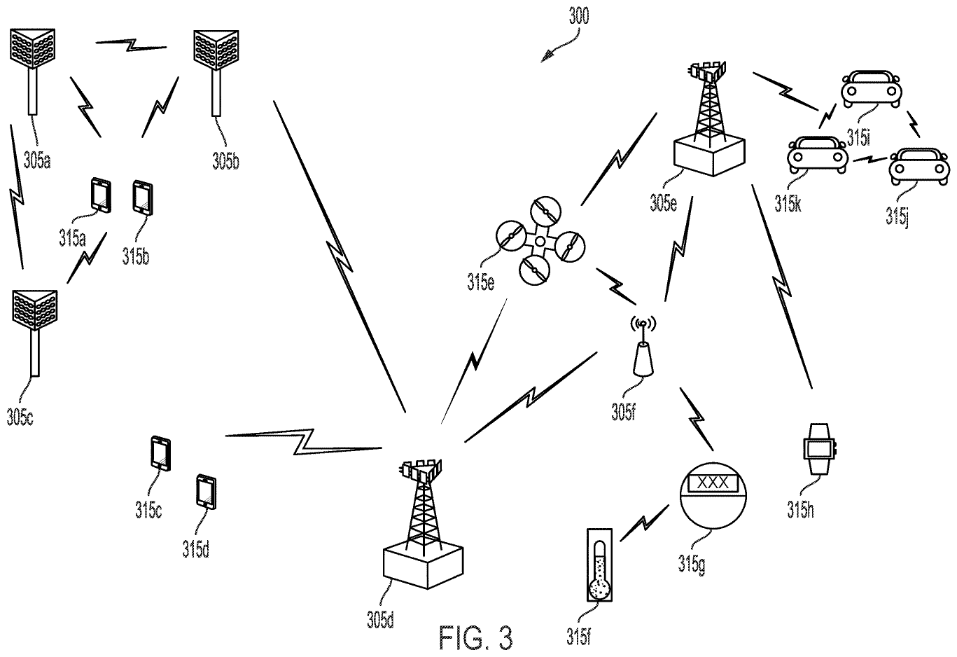

The vehicle 100 may communicate as a user equipment (UE) within a wireless network 300, such as through WAN adaptor 252, as shown in FIG. 3. FIG. 3 is a block diagram illustrating details of an example wireless communication system according to one or more aspects. Wireless network 300 may, for example, include a 5G wireless network. As appreciated by those skilled in the art, components appearing in FIG. 3 are likely to have related counterparts in other network arrangements including, for example, cellular-style network arrangements and non-cellular-style-network arrangements (e.g., device-to-device or peer-to-peer or ad-hoc network arrangements, etc.).

Wireless network 300 illustrated in FIG. 3 includes base stations 305 and other network entities. A base station may be a station that communicates with the UEs and may also be referred to as an evolved node B (eNB), a next generation eNB (gNB), an access point, and the like. Each base station 305 may provide communication coverage for a particular geographic area. In 3GPP, the term “cell” may refer to this particular geographic coverage area of a base station or a base station subsystem serving the coverage area, depending on the context in which the term is used. In implementations of wireless network 300 herein, base stations 305 may be associated with a same operator or different operators (e.g., wireless network 300 may include a plurality of operator wireless networks). Additionally, in implementations of wireless network 300 herein, base station 305 may provide wireless communications using one or more of the same frequencies (e.g., one or more frequency bands in licensed spectrum, unlicensed spectrum, or a combination thereof) as a neighboring cell. In some examples, an individual base station 305 or UE 315 may be operated by more than one network operating entity. In some other examples, each base station 305 and UE 315 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 3, base stations 305d and 305e are regular macro base stations, while base stations 305a-305c are macro base stations enabled with one of three-dimension (3D), full dimension (FD), or massive MIMO. Base stations 305a-305c take advantage of their higher dimension MIMO capabilities to exploit 3D beamforming in both elevation and azimuth beamforming to increase coverage and capacity. Base station 305f is a small cell base station which may be a home node or portable access point. A base station may support one or multiple (e.g., two, three, four, and the like) cells.

Wireless network 300 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 315 are dispersed throughout the wireless network 300, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology.

Some non-limiting examples of a mobile apparatus, such as may include implementations of one or more of UEs 315, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), and a vehicle. Although UEs 315a-j are specifically shown as vehicles, a vehicle may employ the communication configuration described with reference to any of the UEs 315a-315k.

In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 315a-315d of the implementation illustrated in FIG. 3 are examples of mobile smart phone-type devices accessing wireless network 300. A UE may also be a machine specifically configured for connected communication, including machine type communication (MTC), enhanced MTC (eMTC), narrowband IoT (NB-IoT) and the like. UEs 315e-315k illustrated in FIG. 3 are examples of various machines configured for communication that access wireless network 300.

A mobile apparatus, such as UEs 315, may be able to communicate with any type of the base stations, whether macro base stations, pico base stations, femto base stations, relays, and the like. In FIG. 3, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 300 may occur using wired or wireless communication links.

In operation at wireless network 300, base stations 305a-305c serve UEs 315a and 315b using 3D beamforming and coordinated spatial techniques, such as coordinated multipoint (CoMP) or multi-connectivity. Macro base station 305d performs backhaul communications with base stations 305a-305c, as well as small cell, base station 305f. Macro base station 305d also transmits multicast services which are subscribed to and received by UEs 315c and 315d. Such multicast services may include mobile television or stream video, or may include other services for providing community information, such as weather emergencies or alerts, such as Amber alerts or gray alerts.

Wireless network 300 of implementations supports communications with ultra-reliable and redundant links for certain devices. Redundant communication links with UE 315e include from macro base stations 305d and 305e, as well as small cell base station 305f. Other machine type devices, such as UE 315f (thermometer), UE 315g (smart meter), and UE 315h (wearable device) may communicate through wireless network 300 either directly with base stations, such as small cell base station 305f, and macro base station 305e, or in multi-hop configurations by communicating with another user device which relays its information to the network, such as UE 315f communicating temperature measurement information to the smart meter, UE 315g, which is then reported to the network through small cell base station 305f. Wireless network 300 may also provide additional network efficiency through dynamic, low-latency TDD communications or low-latency FDD communications, such as in a vehicle-to-vehicle (V2V) mesh network between UEs 315i-315k communicating with macro base station 305e.

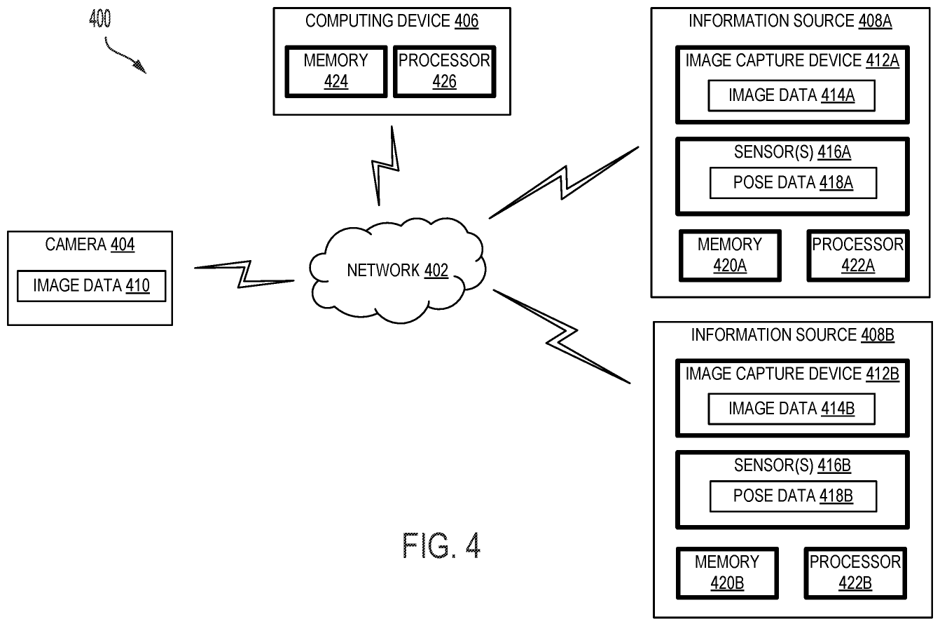

FIG. 4 is a block diagram illustrating an example implementation of the aspects described with reference to FIGS. 1 to 3. Specifically, FIG. 4 is a block diagram of an example computer network 400 for calibrating a camera based on information from sources (e.g., vehicle sensors) that have an overlapping field-of-view with the camera. In various examples, the computer network 400 may be the wireless network 300 described above. Generally, the computer network 400 includes various devices communicating and functioning together in the gathering, transmitting, and/or requesting of data related to camera calibration. As illustrated, a communications network 402 allows for communication in the computer network 400. The communications network 402 may include one or more wireless networks such as, but not limited to one or more of a Local Area Network (LAN), Wireless Local Area Network (WLAN), a Personal Area Network (PAN), Campus Area Network (CAN), a Metropolitan Area Network (MAN), a Wide Area Network (WAN), a Wireless Wide Area Network (WWAN), Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, LTE networks, enhanced data rates for GSM evolution (EDGE), General packet radio service (GPRS), enhanced GPRS, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols. The communications network 402 can, in some instances, include one or more wired connections between devices.

The computer network 400 includes a camera 404 (e.g., a public surveillance camera, such as a traffic camera) in communication with a computing device 406 (e.g., a server, such as a car-to-cloud server) over the communications network 402. In an example, the computing device 406 may be one of the base stations 305 described above. The computing device 406 includes a memory 424 in communication with a processor 426. In various embodiments, the camera 404 may be a camera located outside and subject to environmental conditions, such as a traffic camera. The camera 404 may capture and transmit image data 410, which may include visual keypoints and descriptors of the scene represented by the image data, to the computing device 406. The example computer network 400 further includes an information source 408A and an information source 408B. Each of the information sources 408A and 408B may communicate as one of the UEs 315 described above. For instance, each of the information sources 408A and 408B may be a different vehicle 100. In various examples, the computer network 400 may include additional information sources (e.g., a total of 3, 4, 5, 10, 50, 100, 200, 500, 1,500, etc.). Each of the information sources 408A and 408B may include a computing system capable of capturing and transmitting image data and pose data. For example, the information source 408A may include an image capture device 412A (e.g., camera) capable of capturing image data 414A, which may include visual keypoints and descriptors of the scene represented by the image data 414A. The information source 408A may further include one or more sensors 416A capable of collecting pose data 418A relevant to determining a pose (e.g., orientation, location) of the information source 408A. For example, the one or more sensors 416A may include any of the non-camera sensors described above.

The image data 414A and/or the pose data 418A may be stored in a memory 420A of the information source 408A. A processor 422A may process the image data 414A or the pose data 418A as needed and transmit the image data 414A and the pose data 418A to the computing device 406. For example, the processor 422A may determine a pose of the information source 408A based on the pose data 418A collected by the one or more sensors 416A.

In another example, the information source 408B may include an image capture device 412B (e.g., camera) capable of capturing image data 414B, which may include visual keypoints and descriptors of the scene represented by the image data 414B. The information source 408B may further include one or more sensors 416B capable of collecting pose data 418B relevant to determining a pose (e.g., orientation, location) of the information source 408B. For example, the one or more sensors 416B may include any of the non-camera sensors described above.

The image data 414B and/or the pose data 418B may be stored in a memory 420B of the information source 408B. A processor 422B may process the image data 414B or the pose data 418B as needed and transmit the image data 414B and the pose data 418B to the computing device 406. For example, the processor 422B may determine a pose of the information source 408B based on the pose data 418B collected by the one or more sensors 416B.

In an example, each of the information sources 408A and 408B may be a vehicle (e.g., a driving assistance system of an autonomous or non-autonomous vehicle), a smartphone, etc. In one aspect, the information sources 408A and 408B are each a driving assistance system of separate vehicles. In another aspect, the information source 408A is a driving assistance system of a vehicle and the information source 408B is a smartphone.

Aspects of the vehicular systems described with reference to, and shown in, FIG. 1, FIG. 2, FIG. 3, and FIG. 4 may include camera calibration techniques to determine 3D positional coordinates of the camera based on image data captured by the camera and image coordinates of image data captured by other cameras having overlapping fields of view with the camera to be calibrated. For example, the camera to be calibrated may be a traffic camera (or another public surveillance camera) and the other cameras may be cameras included with driving assistance systems of vehicles. The driving assistance systems of these vehicles automatically transmit pose information (e.g., location and orientation) of the vehicles (e.g., as part of a BSM) to a server (e.g., a car-to-cloud server). The server may receive image data from the traffic camera and from each of the vehicle cameras, which may be automatically sent or subsequent to a request from the server. The image data from each of the traffic camera and the vehicle cameras may include keypoints and descriptors of portions of the scene represented by the image data. Shared keypoints between the traffic camera and the vehicle cameras may be determined and used to calculate an orientation and distance of the traffic camera relative to each of the vehicle cameras. With the known location and orientation of the vehicle cameras, the calculated orientation and distance of the traffic camera relative to each of the vehicle cameras, and a keypoint shared by each of the traffic camera and vehicle cameras, 3D positional coordinates of the traffic camera can be determined (e.g., triangulated). When the traffic camera is properly calibrated, the accurate and reliable data from the traffic camera can enhance the driving assistance systems (e.g., advanced driver-assistance system (ADAS) map information) of vehicles.

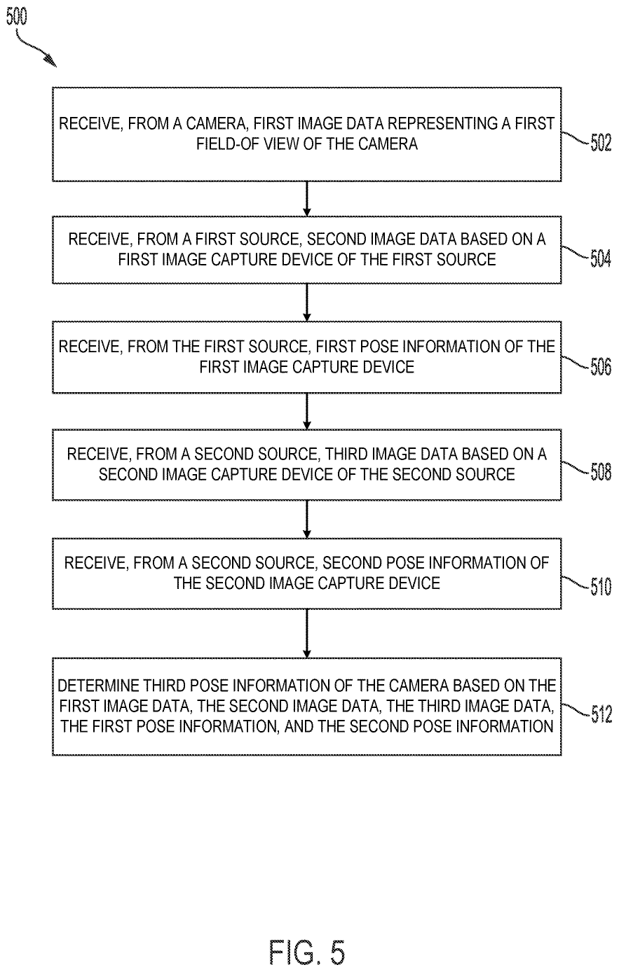

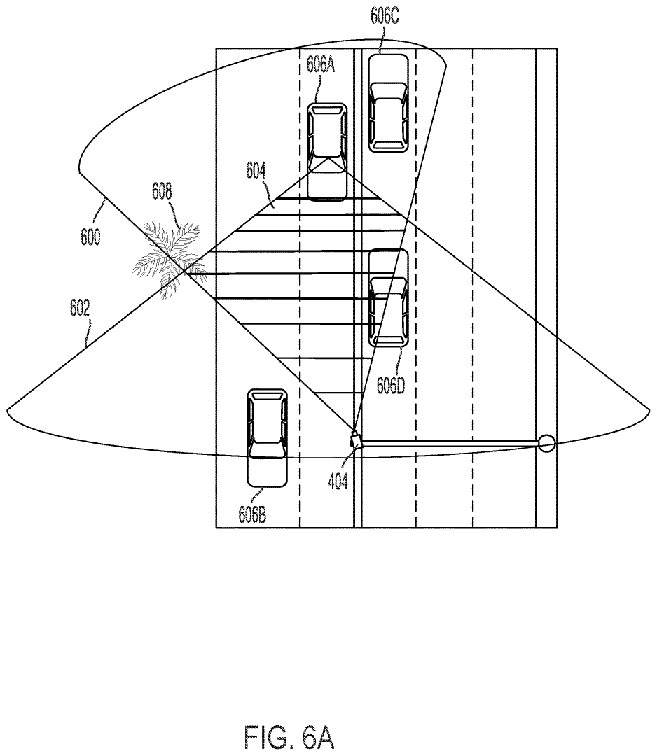

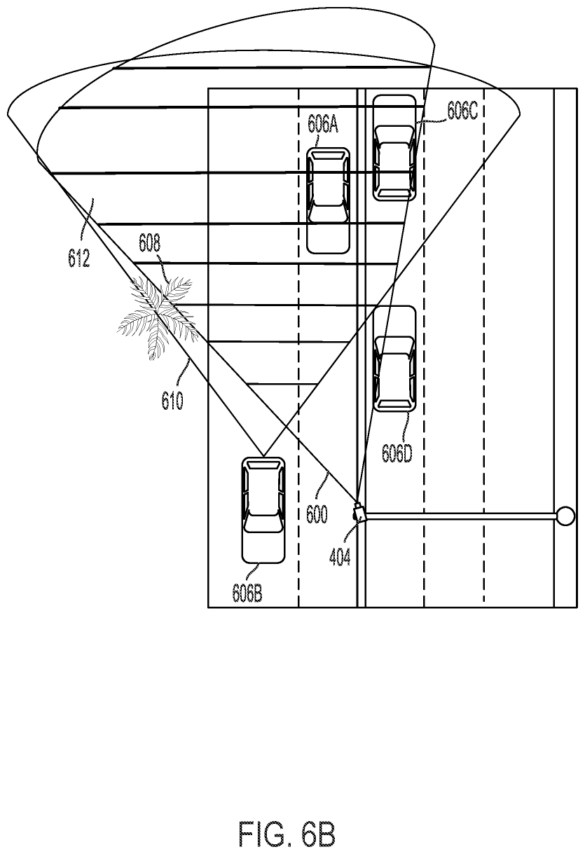

One method of performing image processing according to embodiments described above is shown in FIG. 5. FIG. 5 is a flow chart illustrating an example method for determining (e.g., by computing device 406) a pose of a camera in order to calibrate the camera. A method 500 includes, at block 502, receiving image data (e.g., image data 410) from a camera (e.g., camera 404). The image data 410 represents a field-of view 600 (FIGS. 6A and 6B) of the camera 404 of a scene in front of the camera 404. In some aspects, image data 410 is received in response to transmitting a request for camera 404 to send image data 410 (e.g., on an on-demand basis). For example, a camera (e.g., traffic camera) exposed to environmental conditions is fixed and may only change poses (e.g., rotate and/or translate) occasionally such that camera 404 only needs to be calibrated occasionally. For instance, a request may be transmitted to camera 404 after a storm because the wind, rain, snow, etc. from the storm may have shifted the pose of camera 404. In other aspects, image data 410 may be received from camera 404 continuously or at predetermined intervals (e.g., every 12, 24, or 48 hours, every Sunday, etc.).

The image data 410 may include keypoints of a scene represented by image data 410. Keypoints are pixels in image data 410 that can be tracked from frame to frame, such as corner points. Keypoints of image data 410 can be determined via one of a variety of known techniques (e.g., Harris corner points, Features from Accelerated Segment Test (FAST), Scale-invariant feature transform (SIFT), or Oriented FAST and Rotated BRIEF (ORB). In some aspects, camera 404 determines the keypoints such that the received image data 410 includes the keypoints. In other aspects, computing device 406 may determine the keypoints after image data 410 is received.

Many keypoints have associated descriptors that help with the tracking process. A keypoint plus the keypoint's descriptor is called a feature. Keypoints with descriptors (such as Speeded-Up Robust Features (SURF) or ORB) can be independently redetected in each frame followed by a matching/association procedure. In various aspects, the matched key points may be used to determine an orientation of one image capture device (e.g., camera 404) relative to another image capture device (e.g., image capture device 412A). The relative orientation can be determined via one of a variety of known techniques (e.g., essential matrix, Nister's method, or perspective-n-point (PNP) method).

In various embodiments, image data 410 may include one or more of the following: a key point detection method (e.g., one or more of Harris corner detector, FAST, SURF etc.), a feature descriptor for one or more of the keypoints (e.g., one or more of ORB, SURF, BRIEF), a number of keypoints and associated features to be provided, or intrinsic parameters of camera 404 (e.g., focal length, principal point, lens distortion, image size etc.). In some aspects, image data 410 may include a number of key points, N, to be provided based on an intensity metric for each keypoint specified as the sharpness of a corner, such as in Harris corner measure. For example, keypoints corresponding to the first N highest corners may be included in image data 410. In some aspects, image data 410 may include keypoints uniformly sampled in the image space captured based on the field-of-view 600 of camera 404. In some aspects, the image data 410 may include raw or compressed image data.

At block 504, second image data (e.g., image data 414A) based on a first image capture device (e.g., image capture device 412A) of a first source (e.g., information source 408A) is received from the first source. The image data 414A represents a field-of view 602 (FIG. 6A) of image capture device 412A of a scene in front of image capture device 412A. The field-of-view 602 of image capture device 412A overlaps at least partially with the field-of-view 600 of camera 404. In some aspects, image data 414A is received in response to transmitting a request for information source 408A (e.g., which may be one or a series of vehicles that share a field-of-view with camera 404 over a period of time after the request is received) to send image data 414A (e.g., on an on-demand basis). For example, as described above, camera 404 may only need to be calibrated occasionally.

In another example, a request may be transmitted to information source 408A, and image data 414A received from information source 408A, in response to image capture device 412A of information source 408A being located within a geographic area predetermined to have a high likelihood of an overlap between the field-of-view 600 of camera 404 and the field-of-view 602 of image capture device 412A. The predetermined geographic area may be based on already transmitted image data 414A, by other information sources 408A located within the predetermined geographic area, with keypoints that meet a matching threshold with the keypoints in image data 410 transmitted by camera 404. In embodiments in which information source 408A is a driving assistance system of a vehicle, information source 408A transmits, continuously or on predetermined intervals, a location of information source 408A (e.g., as part of a Basic Safety Message (BSM)) to the computing device 406, which may be used to determine whether the vehicle is within the predetermined geographic area.

In another example, a request may be transmitted to information source 408A, and image data 414A received from information source 408A, in response to image capture device 412A of information source 408A having an orientation within a predetermined range of orientations (e.g., pitch, roll, and/or yaw of image capture device 412A is within the predetermined range). The predetermined range of orientations may be based on already transmitted image data 414A, by other information sources 408A having an orientation within the predetermined range of orientations, with keypoints that meet a matching threshold with the keypoints in image data 410 transmitted by camera 404. In embodiments in which information source 408A is a driving assistance system of a vehicle, information source 408A transmits, continuously or on predetermined intervals, an orientation of information source 408A (e.g., as part of a Basic Safety Message (BSM)) to the computing device 406, which may be used to determine whether the vehicle's orientation is within the predetermined range of orientations.

In other aspects, image data 414A may be received from information source 408A (e.g., which may be one or a series of vehicles that share a field-of-view with camera 404) continuously or at predetermined intervals (e.g., every 12, 24, or 48 hours, every Sunday, etc.).

The image data 414A may include keypoints of a scene represented by image data 414A. In various embodiments, the image data 414A may include one or more of the following: a key point detection method (e.g., one or more of Harris corner detector, FAST, SURF etc.), a feature descriptor for one or more of the keypoints (e.g., one or more of ORB, SURF, BRIEF), a number of keypoints and associated features to be provided, or intrinsic parameters of image capture device 412A (e.g., focal length, principal point, lens distortion, image size etc.). In some aspects, image data 414A may include a number of key points, N, to be provided based on an intensity metric for each keypoint specified as the sharpness of a corner, such as in Harris corner measure. For example, keypoints corresponding to the first N highest corners may be included in image data 414A. In some aspects, image data 414A may include keypoints uniformly sampled in the image space captured based on the field-of-view 602 of image capture device 412A. In some aspects, the image data 414A may include raw or compressed image data.

At block 506, first pose information (e.g., pose data 418A) of image capture device 412A is received from information source 408A. The pose data 418A may be collected by one or more sensors (e.g., sensor(s) 416A) of information source 408A. In embodiments in which information source 408A is a driving assistance system of a vehicle, pose data 418A may be received as part of a Basic Safety Message (BSM). The pose data 418A includes an orientation (e.g., pitch, roll, and/or yaw) of image capture device 412A and/or a location of image capture device 412A. In an example, the orientation of image capture device 412A might be indicated by which camera on a vehicle the image data is retrieved from, such as the bumper camera, the windshield camera, the mirror camera, etc. In some aspects, the location of image capture device 412A is a center of image capture device 412A. In other aspects, the location of image capture device 412A is a location of image capture device 412A offset from the center of image capture device 412A. In such other aspects, the pose data 418A includes offset data which denotes a relative location of the center of image capture device 412A from the reported location of image capture device 412A. In at least some aspects, the location of image capture device 412A includes three-dimensional position coordinates. For example, the three-dimensional position coordinates may be part of a world coordinate system (e.g., GPS).

At block 508, third image data based on a second image capture device (e.g., image capture device 412B) of a second source (e.g., information source 408B) is received from the second source. The image data 414B represents a field-of-view 610 (FIG. 6B) of image capture device 412B of a scene in front of image capture device 412B. The field-of-view 610 of image capture device 412B overlaps at least partially with the field-of-view 600 of camera 404.

In some aspects, image data 414B is received in response to transmitting a request for information source 408B (e.g., which may be one or a series of vehicles that share a field-of-view with camera 404 over a period of time after the request is received) to send image data 414B (e.g., on an on-demand basis). For example, as described above, camera 404 may only need to be calibrated occasionally.

In another example, a request may be transmitted to information source 408B, and image data 414B received from information source 408B, in response to image capture device 412B of information source 408B being located within a geographic area predetermined to have a high likelihood of an overlap between the field-of-view 600 of camera 404 and the field-of-view 602 of image capture device 412B. The predetermined geographic area may be based on already transmitted image data 414B, by other information sources 408B located within the predetermined geographic area, with keypoints that meet a matching threshold with the keypoints in image data 410 transmitted by camera 404. In embodiments in which information source 408B is a driving assistance system of a vehicle, information source 408B transmits, continuously or on predetermined intervals, a location of information source 408B (e.g., as part of a Basic Safety Message (BSM)) to the computing device 406, which may be used to determine whether the vehicle is within the predetermined geographic area.

In another example, a request may be transmitted to information source 408B, and image data 414B received from information source 408B, in response to image capture device 412B of information source 408B having an orientation within a predetermined range of orientations (e.g., pitch, roll, and/or yaw of image capture device 412B is within the predetermined range). The predetermined range of orientations may be based on already transmitted image data 414B, by other information sources 408B having an orientation within the predetermined range of orientations, with keypoints that meet a matching threshold with the keypoints in image data 410 transmitted by camera 404. In embodiments in which information source 408B is a driving assistance system of a vehicle, information source 408B transmits, continuously or on predetermined intervals, an orientation of information source 408B (e.g., as part of a Basic Safety Message (BSM)) to the computing device 406, which may be used to determine whether the vehicle's orientation is within the predetermined range of orientations.

In other aspects, image data 414B may be received from information source 408B (e.g., which may be one or a series of vehicles that share a field-of-view with camera 404) continuously or at predetermined intervals (e.g., every 12, 24, or 48 hours, every Sunday, etc.).

The image data 414B may include keypoints of a scene represented by image data 414B. In various embodiments, the image data 414B may include one or more of the following: a key point detection method (e.g., one or more of Harris corner detector, FAST, SURF etc.), a feature descriptor for one or more of the keypoints (e.g., one or more of ORB, SURF, BRIEF), a number of keypoints and associated features to be provided, or intrinsic parameters of image capture device 412B (e.g., focal length, principal point, lens distortion, image size etc.). In some aspects, image data 414B may include a number of key points, N, to be provided based on an intensity metric for each keypoint specified as the sharpness of a corner, such as in Harris corner measure. For example, keypoints corresponding to the first N highest corners may be included in image data 414B. In some aspects, image data 414B may include keypoints uniformly sampled in the image space captured based on the field-of-view 602 of image capture device 412B. In some aspects, the image data 414B may include raw or compressed image data.

At block 510, second pose information (e.g., pose data 418B) of the image capture device 412B is received from the information source 408B. The pose data 418B may be collected by one or more sensors (e.g., sensor(s) 416B) of the information source 408B. In embodiments in which information source 408B is a driving assistance system of a vehicle, pose data 418B may be received as part of a Basic Safety Message (BSM). The pose data 418B includes an orientation (e.g., pitch, roll, and/or yaw) of image capture device 412B and/or a location of image capture device 412B. In an example, the orientation of image capture device 412B might be indicated by which camera on a vehicle the image data is retrieved from, such as the bumper camera, the windshield camera, the mirror camera, etc. In some aspects, the location of image capture device 412B is a center of image capture device 412B. In other aspects, the location of image capture device 412B is a location of image capture device 412B offset from the center of image capture device 412B. In such other aspects, the pose data 418B includes offset data which denotes a relative location of the center of image capture device 412B from the reported location of image capture device 412B. In at least some aspects, the location of image capture device 412B includes three-dimensional position coordinates. For example, the three-dimensional position coordinates may be part of a world coordinate system (e.g., GPS).

At block 512, third pose information of camera 404 may be determined based on image data 410, image data 414A, image data 414B, pose data 418A of information source 408B, and pose data 418B of information source 408B. Stated differently, the third pose information of camera 404 may be determined based on a known location and/or orientation of image capture devices 412A and 412B of information sources 408A and 408B, respectively, and on image data captured by each of camera 404 and image capture devices 412A and 412B. For instance, image data 410, image data 414A, and image data 414B may include shared reference points (e.g., keypoints) between image data 410 and image data 414A, between image data 410 and image data 414B, and/or between image data 410, 414A, and 414B. Stated differently, first pixel data indicative of a first overlap between the first field-of-view of camera 404 and the second field-of-view of image capture device 414A may be determined. The first pixel data may include keypoints. Second pixel data indicative of a second overlap between the first field-of-view of camera 404 and the third field-of-view of image capture device 412B can also be determined. The second pixel data may include keypoints. In some aspects, third pixel data indicative of a third overlap between the first field-of-view of camera 404, the second field-of-view of image capture device 414A, and the third field-of-view of image capture device 412B can be determined. The third pixel data may include keypoints.

For example, FIGS. 6A and 6B show an example use case in which image capture devices of vehicles have overlapping fields-of-view with camera 404. FIG. 6A shows camera 404 having a field-of-view 600 of the scene in front of camera 404. Vehicle 606A and the driving assistance system (as information source 408A) of vehicle 606A are shown with a front-facing camera (e.g., image capture device 412A) having a field-of-view 602. The field-of-view 600 and the field-of-view 602 overlap in the region 604 indicated by dashed lines. The pixel data representing the scene within the region 604, in this example, is the first pixel data referenced above. Because of the overlap in region 604 between field-of-view 600 of camera 404 and field-of-view 602 of the front-facing camera of vehicle 606A, pixel data representing region 604 includes at least one pixel from the image data (e.g., image data 410) captured by camera 404 and at least one pixel from the image data (e.g., image data 414A) captured by the front-facing camera of vehicle 606A.

In at least some aspects, image data 410 may include one or more keypoints, such as, in this example, pixels representing a portion of vehicle 606A, vehicle 606C, or vehicle 606D, pixels representing a portion of a tree 608, or pixels representing a portion of the road on which vehicles 606A, 606B, 606C, and 606D are driving. In this example, image data 414A may include one or more keypoints, such as pixels representing a portion of vehicle 606A, vehicle 606B, or vehicle 606D, pixels representing camera 404, pixels representing a portion of the tree 608, or pixels representing a portion of the road on which 606A, 606B, 606C, and 606D are driving. In this example, keypoints of vehicle 606A and vehicle 606D, a portion of the tree 608, and a portion of the road on which 606A, 606B, 606C, and 606D are driving are within the overlap region 604. In some aspects, camera 404 may transmit to computing device 406 keypoints of the scene within field-of-view 600, the driving assistance system of vehicle 606A may transmit to computing device 406 keypoints of the scene within field-of-view 602 of the front-facing camera of vehicle 606A, and computing device 406 may determine shared keypoints of camera 404 and vehicle 606A within region 604 based on the keypoints of camera 404 and the keypoints of vehicle 606A.

FIG. 6B shows camera 404 having a field-of-view 600 of the scene in front of camera 404. Vehicle 606B and the driving assistance system (as information source 408B) of vehicle 606B are shown with a rear-facing camera (e.g., image capture device 412B) having a field-of-view 610. The field-of-view 600 and the field-of-view 610 overlap in the region 612 indicated by dashed lines. The pixel data representing the scene within the region 612, in this example, is the second pixel data referenced above. Because of the overlap in region 612 between field-of-view 600 of camera 404 and field-of-view 610 of the rear-facing camera of vehicle 606B, pixel data representing region 612 includes at least one pixel from the image data (e.g., image data 410) captured by camera 404 and at least one pixel from the image data (e.g., image data 414B) captured by the rear-facing camera of vehicle 606B.

In this example, image data 414B may include one or more keypoints, such as pixels representing a portion of vehicle 606A or vehicle 606C, pixels representing a portion of the tree 608, or pixels representing a portion of the road on which 606A, 606B, 606C, and 606D are driving. The keypoints of camera 404 are the same as described in connection with FIG. 6A. In this example, keypoints of vehicle 606A and vehicle 606C, a portion of the tree 608, and a portion of the road on which 606A, 606B, 606C, and 606D are driving are within the overlap region 612. In some aspects, camera 404 may transmit to computing device 406 keypoints of the scene within field-of-view 600, the driving assistance system of vehicle 606B may transmit to computing device 406 keypoints of the scene within field-of-view 610 of the rear-facing camera of vehicle 606B, and computing device 406 may determine shared keypoints of camera 404 and vehicle 606B within region 604 based on the keypoints of camera 404 and the keypoints of vehicle 606B.

It will be appreciated that, any of the keypoints described in connection with FIGS. 6A and 6B may also include descriptors. Additionally, while not shown in FIGS. 6A and 6B, vehicles 606C and 606D may also have image capture devices that have overlapping fields-of-view with camera 404. Additionally, as vehicles 606A, 606B, 606C, and 606D continue moving in a respective direction of travel, new vehicles will appear that have overlapping fields of view with camera 404. The information collected and transmitted by camera 404 and the many vehicles driving in the vicinity of camera 404 enables computing device 406 to utilize crowdsourcing for the determinations of computing device 406.

The pose of camera 404 includes a location and an orientation of camera 404. The orientation of camera 404 can be determined based on orientations of camera 404 relative to image capture devices 412A and 412B of information sources 408A and 408B. In various aspects, the orientation of camera 404 relative to image capture device 412A may be determined based on the pixel data representing overlap region 604 and the known orientation of image capture device 412A. Similarly, the orientation of camera 404 relative to image capture device 412B may be determined based on the pixel data representing overlap region 612 and the known orientation of image capture device 412B. In these aspects, the orientation of camera 404 may be determined based on the known orientations of image capture devices 412A and 412B, and on the relative orientations of camera 404 to each of image capture devices 412A and 412B.

In at least some aspects, the location of camera 404 includes three-dimensional position coordinates on a world coordinate system (e.g., GPS). The location of camera 404 may be determined based on pixel data indicative of an overlap between region 604 and region 612, the known locations and orientations of image capture devices 412A and 412B, a distance between camera 404 and image capture device 412A, and a distance between camera 404 and image capture device 412B. In various aspects, the distance between camera 404 and image capture device 412A is determined based on the pixel data representing region 604 (e.g., shared keypoints between camera 404 and image capture device 412A). In various aspects, the distance between camera 404 and image capture device 412B is determined based on the pixel data representing region 612 (e.g., shared keypoints between camera 404 and image capture device 412B).

In an example, the computing device 406 determines the relative orientations and distances of camera 404 to image capture device 412A and 412B based on known processing techniques (e.g., essential matrix, Nister's method, or perspective-n-point (PNP) method). In this example, upon receiving keypoints & descriptors from i^{th} information source (e.g., information source 408A), vᵢ, the computing device 406 matches the descriptors of vᵢ with the descriptors sent by camera 404 to determine corresponding keypoints. From the corresponding keypoints, and using the known processing technique, the computing device 406 obtains the relative orientation Rᵢ and relative distance between camera 404 and image capture device 412A. Letting \tilde{R}ᵢ be the absolute pose of vᵢ (e.g., obtained from the BSM of the driving assistance system of information source 408A), the orientation of camera 404,

$${R}_{i}^{c}$$

is determined to be

$${R}_{i}^{c} = {R}_{i} \cdot {\tilde{R}}_{i} .$$

In at least some aspects, computing device 406 obtains the net orientation of camera 404 (from all the n information sources that computing device 406 configured to transmit keypoints to computing device 406), as

$${R}^{c} = ( \frac{1}{n} ) {R}_{i}^{c} .$$

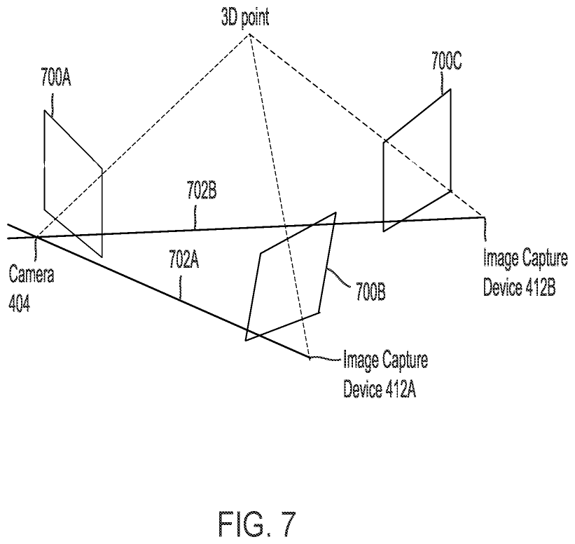

The location of the camera 404 can be determined (e.g., triangulated) based on the known orientations and locations of the image capture devices 412A and 412B, the determined relative orientations and distances between camera 404 and image capture devices 412A and 412B, and a common point that is in the field-of-view of each of camera 404, image capture device 412A, and image capture device 412B. For example, FIG. 7 is a schematic showing a location of camera 404 triangulated based on the above parameters. FIG. 7 shows camera 404 and image capture devices 412A and 412B all viewing a 3D point. The locations of image capture device 412A and 412B are known. The 3D point is projected onto image planes 700A, 700B, and 700C of camera 404 and image capture devices 412A and 412B, respectively, which indicates an orientation of each of each of camera 404 and image capture devices 412A and 412B. The orientation of each of the image capture devices 412A and 412B is known, whereas the orientation of camera 404 relative to image captures devices 412A and 412B has been determined. The vector 702A illustrates a determined distance of camera 404 to image capture device 412A. The vector 702B illustrates a determined distance of camera 404 to image capture device 412A.

The vector 702A itself is not sufficient to determine the unknown location of camera 404. However, with vector 702B (and more distance vectors determined for additional image capture devices) the unknown location of camera 404 can be triangulated. When additional distance vectors are available, the intersection point of all the distance vectors yields the location of camera 404.

FIG. 7 shows the simplest case of determining the intersection point with two systems including image capture devices 412A and 412B, respectively. In other cases, data may be collected from more than two systems having respective image capture devices and a least squares problem may be formulated to determine the closest intersection point yielding the location of camera 404.

In other embodiments, determining the location of the camera 404 may involve a joint optimization problem of determining the projection matrix of the camera 404. For example, let P₁, P₂, . . . Pₙ be the known projection matrices of vehicles v₁, v₂, . . . vₙ respectively. Let xᵢⱼ represent the pixel point corresponding to the i^{th} 3D point as seen by vehicle vⱼ (e.g., image capture device of vehicle vᵢ). Let X₁, X₂ . . . Xₘ be the 3D points seen by vehicles and camera 404. The objective in this example is to jointly determine P₀, X₁, X₂ . . . Xₘ given Xᵢⱼ and Pₖ (k=1,2 . . . n). The following optimization problem can be solved (e.g., like a bundle adjustment) as min

$${\sum }_{i = 0}^{n} {\sum }_{j = 1}^{m} d ( {x}_{ij} , {P}_{i} {X}_{j} ) .$$

Here P₀Xⱼ determines the pixel coordinates of the 3D points in camera 404, and d is a function that determines an appropriate distance measure involving the 3D points and its corresponding pixel coordinates between the vehicle and camera 400. In some aspects of these other embodiments, the techniques described above in connection with FIG. 7, including determining the relative orientations and relative distances, may be used to initialize the joint optimization problem. It is also noted that while these other embodiments were described in relation to vehicles, the concepts of these other embodiments apply to other types of information sources as well.

Returning to the FIG. 5, the method 500, in some embodiments, may be repeated any suitable quantity of times as additional information sources (e.g., vehicles) pass by camera 404. In other embodiments, information from any suitable quantity of information sources (e.g., vehicles) may be collected prior to determining the pose of camera 404. In some embodiments, the same information sources that provide information to calibrate camera 404 may also provide information to another camera to calibrate that camera as well. For example, a camera of a vehicle driving down a road may have a field-of-view overlapping with a first traffic camera's field-of-view such that information from the vehicle (e.g., from the driving assistance system) can be used to calibrate the pose of the first traffic camera. As the vehicle continues driving down the road, the camera of the vehicle may have a field-of-view overlapping with a second traffic camera's field-of-view such that updated information from the vehicle (e.g., from the driving assistance system) can be used to calibrate the pose of the second traffic camera as well.

It is noted that one or more blocks (or operations) described with reference to FIGS. 4 and 5 may be combined with one or more blocks (or operations) described with reference to another of the figures. For example, one or more blocks (or operations) of FIG. 4 may be combined with one or more blocks (or operations) of FIGS. 1-3. As another example, one or more blocks associated with FIG. 5 may be combined with one or more blocks associated with FIGS. 1-3.

In one or more aspects, techniques for supporting vehicular operations may include additional aspects, such as any single aspect or any combination of aspects described below or in connection with one or more other processes or devices described elsewhere herein. In a first aspect, an apparatus is configured to perform operations including: receiving, from a camera, first image data representing a first field-of view of the camera; receiving, from a first source, second image data based on a first image capture device of the first source; receiving, from the first source, first pose information of the first image capture device; receiving, from a second source, third image data based on a second image capture device of the second source; receiving, from the second source, second pose information of the second image capture device; and determining, by a processor, third pose information of the camera based on the first image data, the second image data, the third image data, the first pose information, and the second pose information. The second image data represents a second field-of-view of the first image capture device, and the second field-of-view overlaps at least partially with the first field-of-view. The third image data represents a third field-of-view of the second image capture device, and the third field-of-view overlaps at least partially with the first field-of-view. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, at least one of the first source or the second source is a driving assistance system of a vehicle.

In a third aspect, in combination with one or more of the first aspect or the second aspect, the first image data includes a first keypoint associated with a first reference point included in a first scene represented by the first image data, and the second image data includes a second keypoint associated with the first reference point included in a second scene represented by the second image data.

In a fourth aspect, in combination with one or more of the first aspect through the third aspect, the first pose information includes a first orientation of the first image capture device, and wherein the second pose information includes a second orientation of the second image capture device.

In a fifth aspect, in combination with the fourth aspect, determining the third pose information of the camera includes determining: a third orientation of the camera relative to the first source based on the first image data, the second image data, and the first orientation; a fourth orientation of the camera relative to the second source based on the first image data, the second image data, and the second orientation; and a fifth orientation of the camera based on the first orientation, the second orientation, the third orientation, and the fourth orientation. The third pose information of the camera includes the fifth orientation.

In a sixth aspect, in combination with one or more of the first aspect through the fifth aspect, the first pose information includes a first location of the first image capture device, and the second pose information includes a second location of the second image capture device.

In a seventh aspect, in combination with the sixth aspect, the third pose information of the camera includes a third location of the camera, and determining the third location is based on the first image data, the second image data, the third image data, the first location, the first orientation, a first distance between the first source and the camera, the second location, the second orientation, and a second distance between the second source and the camera.

In an eighth aspect, in combination with one or more of the seventh aspect, the apparatus is further configured to determine: first pixel data indicative of a first overlap between the first field-of-view and the second field-of-view; second pixel data indicative of a second overlap between the first field-of-view and the third field-of-view; and the first distance based on the first pixel data and the second distance based on the second pixel data.

In a ninth aspect, in combination with the eighth aspect, the first pixel data includes a first plurality of pixels included in both the first image data and the second image data, the second pixel data includes a second plurality of pixels included in both the first image data and the third image data, the first distance is determined based on the first plurality of pixels, and the second distance is determined based on the second plurality of pixels.

In a tenth aspect, in combination with one or more of the first aspect through the ninth aspect, the first source is a first vehicle, the first image capture device is a first camera of the first vehicle, the second source is a second vehicle, the second image capture device is a second camera of the second vehicle, the second image data is received from the first vehicle through a network, and the third image data is received from the second vehicle through the network.

In an eleventh aspect, an apparatus is configured to perform operations including receiving, from a first traffic camera, first image data; receiving, from each vehicle of a plurality of vehicles, second image data captured by a respective camera of each vehicle of the plurality of vehicles; receiving, from each vehicle of the plurality of vehicles, first pose information of the respective camera of each vehicle of the plurality of vehicles; determining second pose information of the first traffic camera based on the first image data, the second image data of each vehicle of the plurality of vehicles, and the first pose information of each vehicle of the plurality of vehicles; receiving, from a second traffic camera, third image data; receiving, from each vehicle of a plurality of vehicles, fourth image data captured by the respective camera of each vehicle of the plurality of vehicles; receiving, from each vehicle of the plurality of vehicles, third pose information of the respective camera of each vehicle of the plurality of vehicles; determining fourth pose information of the second traffic camera based on the third image data, the fourth image data of each vehicle of the plurality of vehicles, and the third pose information of each vehicle of the plurality of vehicles. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a twelfth aspect, in combination with the eleventh aspect, the first pose information of each vehicle of the plurality of vehicles includes a first orientation of the respective camera of each vehicle of the plurality of vehicles. The third pose information includes a second orientation of the respective camera of each vehicle of the plurality of vehicles.

In a thirteenth aspect, in combination with the twelfth aspect, determining the second pose information of the first traffic camera includes determining: a plurality of third orientations of the first traffic camera relative to each of the respective cameras of each vehicle of the plurality of vehicles; and a fourth orientation. The plurality of third orientations are determined based on the first image data, the second image data of each vehicle of the plurality of vehicles, and the first orientation of the respective camera of each vehicle of the plurality of vehicles. The fourth orientation of the first traffic camera is determined based on the first orientation of the respective camera of each vehicle of the plurality of vehicles and the plurality of third orientations. The second pose information of the first traffic camera includes the fourth orientation.

In a fourteenth aspect, in combination with one or more of the twelfth aspect and the thirteenth aspect, the first orientation of the respective camera of each vehicle of the plurality of vehicles includes a respective location of the respective camera of each vehicle of the plurality of vehicles.

In a fifteenth aspect, in combination with the fourteenth aspect, the second pose information of the first traffic camera includes a location of the first traffic camera, and determining the location of the first traffic camera is based on the first image data, the second image data of each vehicle of the plurality of vehicles, the respective location of the respective camera of each vehicle of the plurality of vehicles, the first orientation of the respective camera of each vehicle of the plurality of vehicles, and a respective distance between each respective camera of each vehicle of the plurality of vehicles and the first traffic camera.

Components, the functional blocks, and the modules described herein with respect to FIGS. 1-4 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method for image processing for use with a vehicle assistance system, comprising:
receiving, from a camera, first image data representing a first field-of-view of the camera;
receiving, from a first source, second image data based on a first image capture device of the first source, wherein the second image data represents a second field-of-view of the first image capture device, wherein the second field-of-view overlaps at least partially with the first field-of-view;
receiving, from the first source, first pose information of the first image capture device;
receiving, from a second source, third image data based on a second image capture device of the second source, wherein the third image data represents a third field-of-view of the second image capture device, wherein the third field-of-view overlaps at least partially with the first field-of-view;
receiving, from the second source, second pose information of the second image capture device; and
determining, by a processor, third pose information of the camera based on the first image data, the second image data, the third image data, the first pose information, and the second pose information.

2. The method of claim 1, wherein at least one of the first source or the second source is a driving assistance system of a vehicle.

3. The method of claim 1, wherein the first image data includes a first keypoint associated with a first reference point included in a first scene represented by the first image data, wherein the second image data includes a second keypoint associated with the first reference point included in a second scene represented by the second image data.

4. The method of claim 1, wherein the first pose information includes a first orientation of the first image capture device, and wherein the second pose information includes a second orientation of the second image capture device.

5. The method of claim 4, wherein determining the third pose information of the camera comprises determining, by the processor:
a third orientation of the camera relative to the first source based on the first image data, the second image data, and the first orientation;
a fourth orientation of the camera relative to the second source based on the first image data, the second image data, and the second orientation; and
a fifth orientation of the camera based on the first orientation, the second orientation, the third orientation, and the fourth orientation,
wherein the third pose information of the camera includes the fifth orientation.

6. The method of claim 4, wherein the first pose information includes a first location of the first image capture device, and wherein the second pose information includes a second location of the second image capture device.

7. The method of claim 6, wherein the third pose information of the camera includes a third location of the camera, wherein determining the third location is based on the first image data, the second image data, the third image data, the first location, the first orientation, a first distance between the first source and the camera, the second location, the second orientation, and a second distance between the second source and the camera.

8. The method of claim 7, further comprising determining, by the processor:
first pixel data indicative of a first overlap between the first field-of-view and the second field-of-view;
second pixel data indicative of a second overlap between the first field-of-view and the third field-of-view; and
the first distance based on the first pixel data and the second distance based on the second pixel data.

9. The method of claim 8, wherein the first pixel data includes a first plurality of pixels included in both the first image data and the second image data, wherein the second pixel data includes a second plurality of pixels included in both the first image data and the third image data, wherein the first distance is determined based on the first plurality of pixels, and wherein the second distance is determined based on the second plurality of pixels.

10. The method of claim 1, wherein the first source is a first vehicle, wherein the first image capture device is a first camera of the first vehicle, wherein the second source is a second vehicle, wherein the second image capture device is a second camera of the second vehicle, wherein the second image data is received from the first vehicle through a network, and wherein the third image data is received from the second vehicle through the network.

11. An apparatus, comprising:
a memory storing processor-readable code; and
at least one processor coupled to the memory, the at least one processor configured to execute the processor-readable code to cause the at least one processor to perform operations including:
receiving, from a camera, first image data representing a first field-of-view of the camera;
receiving, from a first source, second image data based on a first image capture device of the first source, wherein the second image data represents a second field-of-view of the first image capture device, wherein the second field-of-view overlaps at least partially with the first field-of-view;
receiving, from the first source, first pose information of the first image capture device;
receiving, from a second source, third image data based on a second image capture device of the second source, wherein the third image data represents a third field-of-view of the second image capture device, wherein the third field-of-view overlaps at least partially with the first field-of-view;
receiving, from the second source, second pose information of the second image capture device; and
determining third pose information of the camera based on the first image data, the second image data, the third image data, the first pose information, and the second pose information.

12. (canceled)

13. The apparatus of claim 11, wherein the first image data includes a first keypoint associated with a first reference point included in a first scene represented by the first image data, wherein the second image data includes a second keypoint associated with the first reference point included in a second scene represented by the second image data

14. The apparatus of claim 11, wherein the first pose information includes a first orientation of the first image capture device, and wherein the second pose information includes a second orientation of the second image capture device.

15. The apparatus of claim 14, wherein determining the third pose information of the camera comprises determining:
a third orientation of the camera relative to the first source based on the first image data, the second image data, and the first orientation;
a fourth orientation of the camera relative to the second source based on the first image data, the second image data, and the second orientation; and
a fifth orientation of the camera based on the first orientation, the second orientation, the third orientation, and the fourth orientation,
wherein the third pose information of the camera includes the fifth orientation.

16. The apparatus of claim 14, wherein the first pose information includes a first location of the first image capture device, and wherein the second pose information includes a second location of the second image capture device.

17. The apparatus of claim 16, wherein the third pose information of the camera includes a third location of the camera, wherein determining the third location is based on the first image data, the second image data, the third image data, the first location, the first orientation, a first distance between the first source and the camera, the second location, the second orientation, and a second distance between the second source and the camera.

18. The apparatus of claim 17, wherein the operations further include:
determining first pixel data indicative of a first overlap between the first field-of-view and the second field-of-view;
determining second pixel data indicative of a second overlap between the first field-of-view and the third field-of-view; and
determining the first distance based on the first pixel data and the second distance based on the second pixel data.

19-25. (canceled)

26. An apparatus, comprising:
a memory; and
at least one processor coupled to the memory, the at least one processor configured to perform operations including:
receiving, from a first traffic camera, first image data;
receiving, from each vehicle of a plurality of vehicles, second image data captured by a respective camera of each vehicle of the plurality of vehicles;
receiving, from each vehicle of the plurality of vehicles, first pose information of the respective camera of each vehicle of the plurality of vehicles;
determining second pose information of the first traffic camera based on the first image data, the second image data of each vehicle of the plurality of vehicles, and the first pose information of each vehicle of the plurality of vehicles;
receiving, from a second traffic camera, third image data;
receiving, from each vehicle of a plurality of vehicles, respective fourth image data captured by the respective camera of each vehicle of the plurality of vehicles;
receiving, from each vehicle of the plurality of vehicles, third pose information of the respective camera of each vehicle of the plurality of vehicles;
determining fourth pose information of the second traffic camera based on the third image data, the respective fourth image data of each vehicle of the plurality of vehicles, and the third pose information of each vehicle of the plurality of vehicles.

27. The apparatus of claim 26, wherein the first pose information of each vehicle of the plurality of vehicles includes a first orientation of the respective camera of each vehicle of the plurality of vehicles, and wherein the third pose information includes a second orientation of the respective camera of each vehicle of the plurality of vehicles.

28. The apparatus of claim 27, wherein determining the second pose information of the first traffic camera comprises determining:
a plurality of third orientations of the first traffic camera relative to each of the respective cameras of each vehicle of the plurality of vehicles based on the first image data, the second image data of each vehicle of the plurality of vehicles, and the first orientation of the respective camera of each vehicle of the plurality of vehicles; and
a fourth orientation of the first traffic camera based on the first orientation of the respective camera of each vehicle of the plurality of vehicles and the plurality of third orientations,
wherein the second pose information of the first traffic camera includes the fourth orientation.

29-30. (canceled)
